(19) United States
(12) Patent Application Publication
(10) Pub. No.: US 2013/0174089 A1
(43) Pub. Date: Jul. 4, 2013

(54) TERMINAL APPARATUS AND METHOD FOR PROVIDING LIST SELECTION

(71) Applicant: Kyung Jin KI, Seoul (KR)

(72) Inventor: Kyung Jin KI, Seoul (KR)

(73) Assignee: Pantech Co., Ltd., Seoul (KR)

(21) Appl. No.: 13/595,786

(22) Filed: Aug. 27, 2012

(30) Foreign Application Priority Data
Aug. 30, 2011 (KR) 10-2011-0087089

(51) Int. Cl. G06F 3/0482

(52) U.S. Cl. CPC G06F 3/0482
USPC 715/810

(57) ABSTRACT

A terminal to select a list object includes an interface to receive a first flick input for the list object, a controller to convert the list object into a group object, and a processing unit to process the group object according to a received command event. A method for selecting a list object includes receiving a first flick input for the list object, assigning a portion of a display of a terminal as a selected target display region, converting the list object into a group object by associating the list object with the selected target display region, and processing the group object based on a received command event.

### CROSS-REFERENCE TO RELATED APPLICATION

This application claims priority from and the benefit of Korean Patent Application No. 10-2011-0087089, filed on Aug. 30, 2011, which is hereby incorporated by reference for all purposes as if fully set forth herein.

### BACKGROUND

1. Field

Present disclosure relates to a technology for supporting selection, deselection, or grouping of a list object.

2. Discussion of the Background

If a display module supporting a touch input is applied to a device, such as a smart phone and the like, a user interface (UI) having various touch input operations may be is used.

Generally, a smart phone may provide, through a display module, a list in which objects may be arranged. The list of objects may be selected or deselected to apply a command (e.g., delete). Further, the smart phone may also provide a UI to receive a selection and/or deselection of an object and a request to enter a selection mode (e.g., selection screen to select one or more applications to delete from the smart phone). Here, the selection of the object may be indicated by using at least one of a checkbox, a change in color, and a reference marker.

FIG. 1 is a diagram illustrating an example of selecting and deselecting an object arranged in a list in a smart phone according to a conventional art.

Referring to FIG. 1, the smart phone may provide a list in which one or more objects are displayed if the smart phone enters a selection mode. More specifically, a user may request to enter the selection mode on the smart phone, such as a “DELETE” selection mode, which may provide a checkbox 101 to receive a selection of an object in a list or a list object to be deleted. Further, the selected objects may also be deselected in the respective selection mode. In an example, both the selection and the deselection of the object may be referred to as a selection operation. Accordingly, in order to select the object to apply a command, the user may first make the request to enter the selection mode.

### SUMMARY

Exemplary embodiments of the present invention provide an apparatus and a method for selecting, deselecting, and grouping an object.

Additional features of the invention will be set forth in the description which follows, and in part will be apparent from the description, or may be learned by practice of the is invention.

Exemplary embodiments of the present invention provide a terminal to select a list object including an interface to receive a first flick input for the list object, a controller to convert the list object into a group object, and a processing unit to process the group object according to a received command event.

Exemplary embodiments of the present invention provide a method for selecting a list object including receiving a first flick input for the list object, assigning a portion of a display of a terminal as a selected target display region, converting the list object into a group object by associating the list object with the selected target display region, and processing the group object based on a received command event.

Exemplary embodiments of the present invention provide a method for selecting a list object receiving a first flick input for the list object located on a list region, assigning a portion of a display of a terminal as a selected target display region, converting the list object into a group object by associating the list object with the selected target display region, receiving a second flick input for the group object, assigning the group object to a sub-group based on a reference criteria, hiding the list region, receiving a command event for the group object, and processing the group object according to the command event.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a selection of an object arranged in a list in a terminal apparatus according to a conventional art.

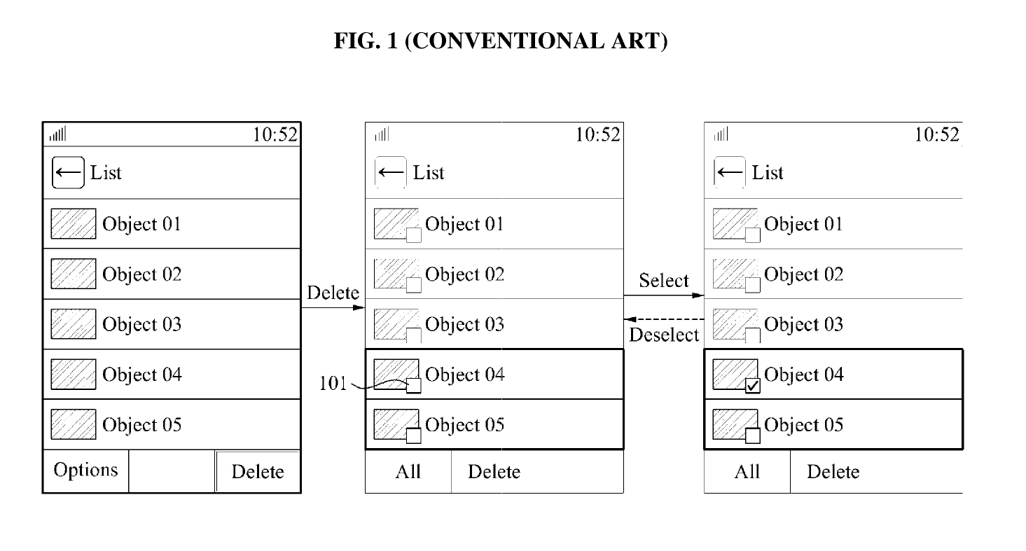

FIG. 2 is a block diagram illustrating a configuration of a terminal apparatus to select a list object using a flicking operation according to an exemplary embodiment of the invention.

FIG. 3 is a diagram illustrating a selection of a list object in a terminal apparatus using a flicking operation according to an exemplary embodiment of the invention.

FIG. 4 is a diagram illustrating a selection of a list of multiple groups in a terminal apparatus using a flicking operation according to an exemplary embodiment of the invention.

FIG. 5 is a diagram illustrating hiding of a list object and canceling the hiding of the list object in a terminal apparatus using a flicking operation according to an exemplary embodiment of the invention.

FIG. 6 is a diagram illustrating hiding of a list object in a terminal apparatus using a flicking operation according to an exemplary embodiment of the invention.

FIG. 7 is a diagram illustrating canceling hiding of a list object in a terminal apparatus using a flicking operation according to an exemplary embodiment of the invention.

FIG. 8 is a diagram illustrating a multi-structure selection in a terminal apparatus using a flicking operation according to an exemplary embodiment of the invention.

FIG. 9 is a diagram illustrating a movement of a group object between groups in a terminal apparatus using a flicking operation according to an exemplary embodiment of the invention.

FIG. 10 is a diagram illustrating a selection of a list object in a terminal apparatus using a flicking operation according to an exemplary embodiment of the invention.

FIG. 11 is a diagram illustrating a selection of a list object in a terminal apparatus using a flicking operation according to an exemplary embodiment of the invention.

FIG. 12 is a flowchart illustrating a method for selecting a list object using a flicking operation according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that if an element is referred to as being “connected to” is another element, it can be directly connected to the other element, or intervening elements may be present.

A terminal apparatus and a method for selecting a list object using a flicking operation according to an exemplary embodiment of the invention will be described in detail with reference to the accompanying drawings. Hereinafter, the flicking operation may refer to touching a point of reference coordinates and dragging the point in a reference direction. The flicking operation may also refer to touching a first input corresponding to a reference coordinate and touching a second input corresponding to a different coordinate. Further, the flicking operation may refer to touching a first input corresponding to a reference coordinate and providing a reference motion, which may be recognized by the terminal apparatus. In addition, the flicking operation may refer to touching a first input for at least a reference period of time. Although various examples of the flicking operations are described herein, the flicking operation is not limited as such.

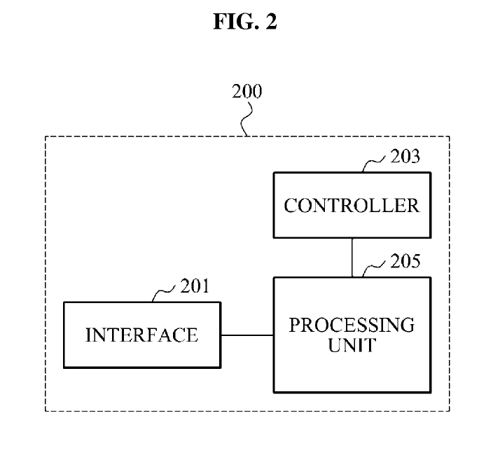

FIG. 2 is a block diagram illustrating a configuration of a terminal apparatus to select a list object using a flicking operation according to an exemplary embodiment of the invention.

Referring to FIG. 2, the terminal apparatus may include an interface 201, a controller 203, and a processing unit 205.

The interface 201 may receive a first flick input for or on an object arranged in a list region or a list object. The interface 201 may receive the first flick input in a direction different from a scrolling direction of a screen used to display the list object. For example, if the scrolling direction corresponds to ‘⇑’ or ‘⇓’, the interface 201 may receive the input of the first flick input in a direction of ‘←’ or ‘→’. Similarly, if the scrolling direction corresponds to ‘←’ is or ‘→’, the interface may receive the input of the first flick input in a direction of ‘⇑’ or ‘⇓’. Although the flicking direction has been described as being opposite of the scrolling direction, it is not limited thereto. The flicking direction may be similar to the scrolling direction, different than the scrolling direction, or in a reference angle with respect to the scrolling direction.

Also, the interface 201 may receive a second flick input for or on a group object. The group object may be formed in association with the first flick input. More specifically, if a list object receives the first flick input, the list object may be converted into a group object.

If the first flick is inputted through the interface 201, the controller 203 may assign a portion of a display unit (not shown) as a selected target display region, and convert the first flicked list object into a group object by associating the list object with the selected target display region. Further, the controller 203 may assign the selected target display region on a side of the display unit in view of an input direction of the first flick. For example, if the first flick is inputted in a right direction, the controller 203 may assign the selected target display region on a right side of the display unit. If the first flick is input in a left direction, the controller 203 may assign the selected target display region on a left side of the display unit.

If the second flick for the group object is inputted through the interface 201, the controller 203 may control the group object for which the second flick is inputted based on an input direction of the second flick. That is, if the second flick is inputted in a direction of the list region, the controller 203 may restore the group object as a list object. If the second flick is inputted in a different direction, such as opposite direction of the list region, the controller 203 may assign another portion of the display unit as a sub-selected target display region, and may associate the group object for which the second flick is inputted with the sub-selection target display region.

For example, if the second flick is inputted with respect to the group object, which may be associated with a selected target display region assigned on the right side of the display unit, in a direction of the list region, the controller 203 may restore the group object to an original state before the first flick was inputted. Also, in a case where the second flick is inputted in an opposite direction of the list region, the controller 203 may support a multi-structure selection by assigning a sub-selected target display region on the right side of the display unit. The controller 203 may associate the group object for which the second flick is inputted with the sub-selected target display region.

The controller 203 may associate the list object with the selected target display region by moving the list object from the list region to the selected target display region or by controlling the object to occupy the selected target display region. The object may be controlled to occupy the selected target display region by expanding the object to be positioned in both the list region and the selected target display region.

If a reference event occurs or is detected, the controller 203 may display a group object selected by the first flick and hide the list objects. In an example, the controller 203 may hide the list region and may display the group object on the display unit by arranging the group object in the selected target display region to be expanded on the display unit if the reference event, such as a touch-open event with respect to the selected target display region or a touch-narrow event with respect to the list region is detected. In an example, the touch-open event may refer to a command or an event, which requests the selected target display region to be expanded or open to view the group objects included in the selected target display region. Further, the touch-narrow event may refer to a command or an event, which requests the list region to be hidden so that the group objects included in the selected target display region may be viewed.

Further, the controller 203 may hide the list region and may display the group object on the display unit by arranging the group object in the selected target display region if an open command event associated with a touch in the selected target display region or a motion event to position a view point in the selected target display region is detected. The controller 203 may expand and display the selected target display region in which the group object is arranged if the list region is hidden. In an example, the open command event associated with the touch in the selected target display region may refer to a touch selection of the target display region to expand a view of the selected target display region. The motion event to position a view point in the selected target display region may refer to a reference movement to direct a targeted view to the selected target display region.

The controller 203 may display both the list object and group object if another reference event occurs or is detected in a state in which the group object is displayed while the list object is hidden. More specifically, the controller 203 may cancel the hiding of the list region, and may display the list object in the list region if at least one of a touch-narrow event with respect to the selected target display region, a narrow command event associated with a touch in the hidden list region, and a motion event to position the view point in the list region is detected. In an example, the touch-narrow event with respect to the selected target display region may refer to a command or an event, which may request to reduce the size of the selected target display region. Similarly, the narrow command event associated with a touch in the hidden list region may refer to a request to restore the list region to be viewed. The motion event to position the view point in the list region may refer to a reference movement to direct a view to the hidden list region.

The controller 203 may support movement of a group object between various groups. In particular, if the selected target display region includes a plurality of regions including a first region and a second region, and the second flick for a reference group object displayed in the first region is inputted, through the interface, in a direction towards the second region, the controller 203 may update and display the reference group object on the display unit by displaying the reference group object in the second region to support the movement of the group object between the groups.

Further, the controller 203 may hide the list region. If a second flick of a first group object displayed in a first region is inputted in a direction towards a second region, the controller 203 may update and display the first group object in the second region. In an example, the first region may be positioned on the left side of the display unit, and the second region may be positioned on the right side of the display unit, or vice versa. Further, the controller 203 may remove, from the first region, the first group object and insert the first group object in the second region based on reference arrangement criteria. The reference arrangement criteria may include, without limitation, a name of an object, a date on which the object is generated, and the like.

The processing unit 205 may process the group object with respect to a command event. For example, the processing unit 205 may delete or upload the group object if a deletion event or an upload event is detected or received.

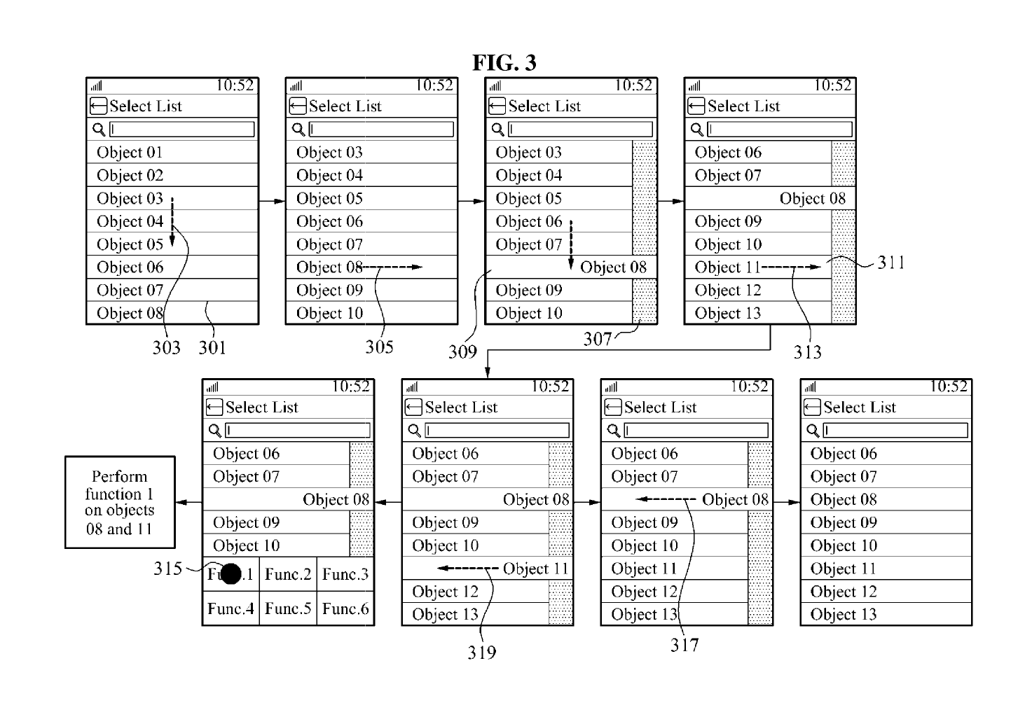

FIG. 3 is a diagram illustrating a selection of a list object in a terminal apparatus using a flicking operation according to an exemplary embodiment of the invention.

Referring to FIG. 3, if a first flick operation is applied on an object 08 309 arranged in a list region 301 in a first direction 305, which may be different from a direction 303 of a scroll used in searching for the object 08 309, the terminal apparatus may assign a portion of a display unit as a selected target display region 307. Further, the terminal apparatus may convert the object 08 309, into a group object, by controlling the object 08 903 to occupy the selected target display region 307 and associating the object 08 309 with the selected target display region 307.

Also, if a second flick operation is applied on an object 11 311 in a second direction 313, the terminal apparatus may convert the object 11 311 into a group object by associating the object 11 311 with the selected target display region 307. In an example, the first direction 305 and the second direction 313 may be similar or the same.

The terminal apparatus may execute function 1 315, associated with a selection received on a provided menu, on the object 08 309 and the object 11 311 that may be converted into group objects.

Also, if a third flick operation is applied on the group object, which may include object 08 309 and object 11 311, in a third direction 317 or a fourth direction 319 of the list region 301, the terminal apparatus may restore the object 08 309 or the object 11 311 to be arranged in the list region 301, respectively, thereby restoring the object to an original state before the first flick was received.

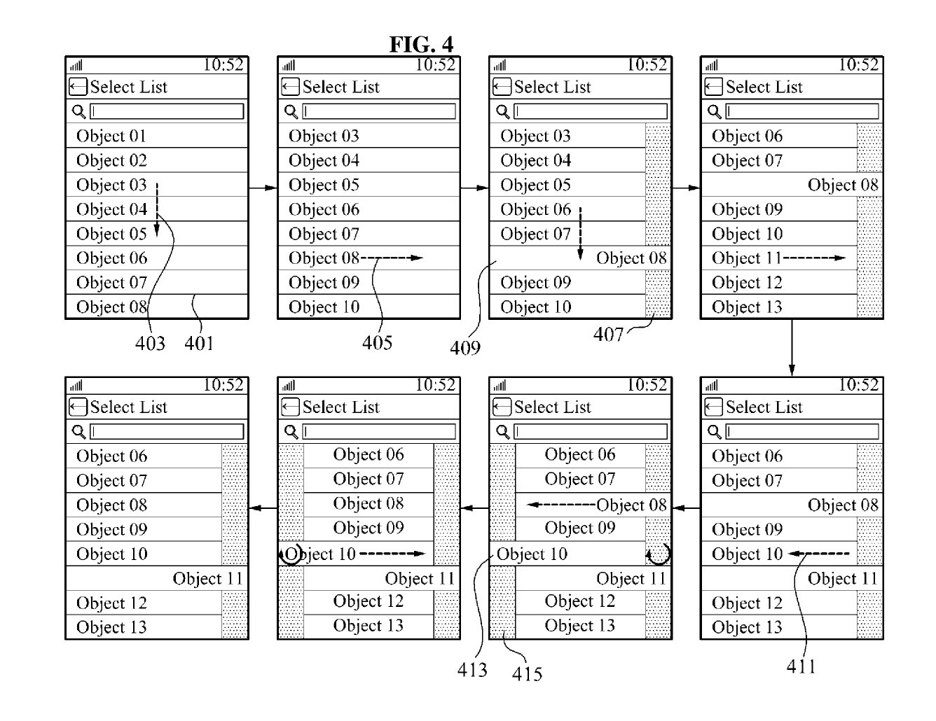

FIG. 4 is a diagram illustrating a selection of a list of multiple groups in a terminal apparatus using a flicking operation according to an exemplary embodiment of the invention.

Referring to FIG. 4, if a first flick operation is applied on an object 08 409 arranged in a list region 401 in a first direction 405, which may be different from a direction 403 of a scroll used to search for the object 08 409, the terminal apparatus may convert the object 08 409 into a first group object by associating the object 08 409 with a selected target display region 407 positioned on a right side of a display unit.

If a second flick operation is applied on an object 10 413 arranged in the list region 401 in a second direction 411, which may be different from the first direction 405, the terminal apparatus may convert the object 10 413 into a second group object by associating the object 10 413 with a selected target display region 415 positioned on a left side of the display unit.

Accordingly, the terminal apparatus may establish an environment in which different functions or operations may be performed on respective group objects, by converting some objects arranged in the list region 401 into first group objects and second group objects.

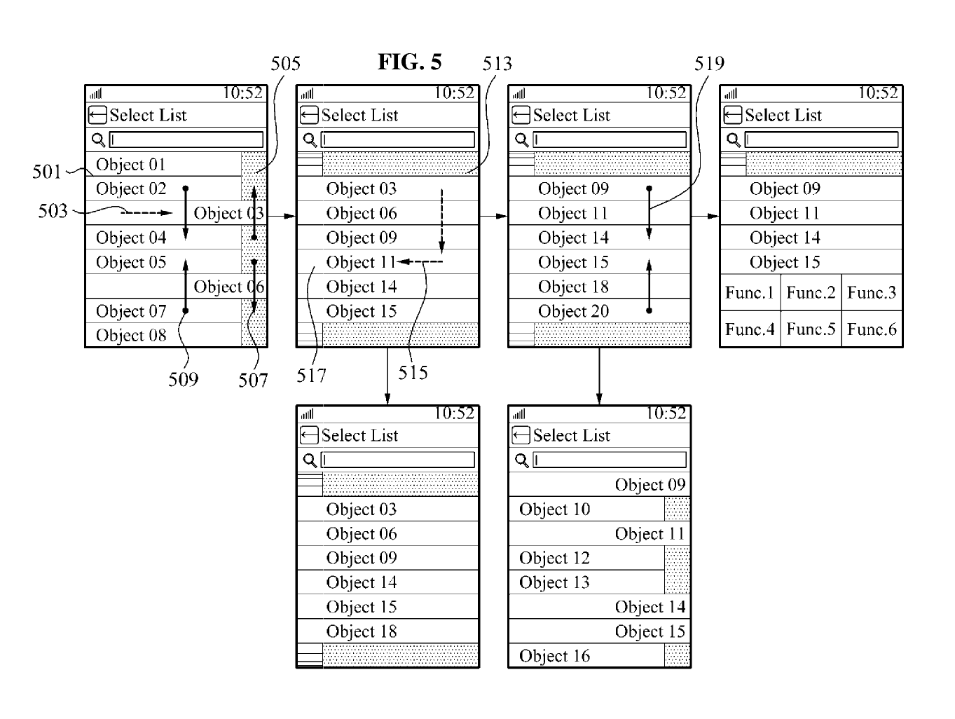

FIG. 5 is a diagram illustrating hiding of a list object and canceling the hiding of the list object in a terminal apparatus using a flicking operation according to an exemplary embodiment of the invention.

Referring to FIG. 5, if a touch-open event 507 with respect to a selected target display region 505 or a touch-narrow event 509 with respect to a list region 501 occurs, the terminal apparatus may hide the list region 501 and display the group object to be arranged in an expanded selected target display region 513. The touch-open event 507 or the touch-narrow event 509 may occur if a first flick is applied on a first direction 503, in which the object is converted into a group object by associating the object with the selected target display region 505. In an example, the touch-open event 507 may refer to a command or an event, which requests the selected target display region to be expanded or open to view the group objects included in the selected target display region. Further, the touch-narrow event 509 may refer to a command or an event, which requests the list region to be hidden so that the group objects included in the selected target display region may be viewed. The terminal apparatus may perform an operation or a function associated with a received selection input on a provided menu is on the group object.

Further, if the first flick is inputted for the group object arranged in the selected target display region 513, that is, an object 11 517, in a second direction 515 of the list region 501, the terminal apparatus may remove the group object for which the first flick is inputted, that is, the object 11 517, from the selected target display unit 513.

Also, if a touch-narrow event 519 with respect to the selected target display region 513 in which the group object is arranged occurs, the terminal apparatus may cancel the hiding of the list region 501, and may display both an unaffected list object and the group object selected by the input of the first flick to be arranged in the list region 501.

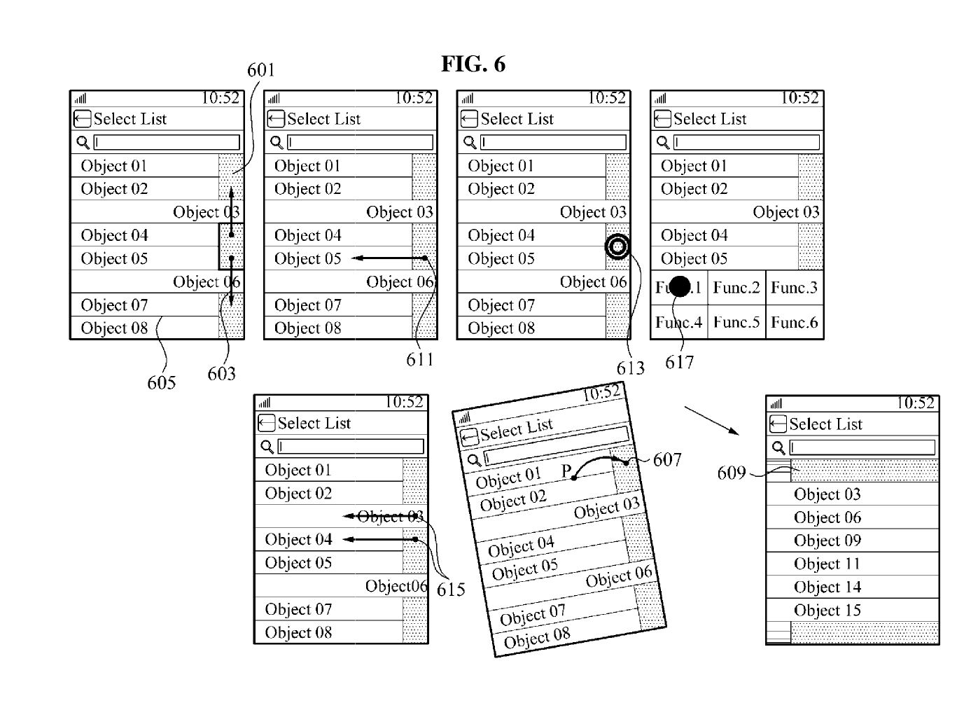

FIG. 6 is a diagram illustrating hiding of a list object in a terminal apparatus using a flicking operation according to an exemplary embodiment of the invention.

Referring to FIG. 6, the terminal apparatus may hide a list region 605 and may display a group object to be arranged in a selected target display region 609, if a touch-open event 603 with respect to a selected target display region 601, an open command event associated with a touch in the selected target display region 601, or a motion event to position a view point 607 in the selected target display region 601 is detected.

For example, the terminal apparatus may hide the list region 605 and display the group object to be arranged in the selected target display region 609 if i) a flick operation is applied in a direction of the list region 605, from a reference point 611, which may not occupied by the group object in the selected target display region 601, ii) a reference point 613, which may not occupied by the group object in the selected target display region 601, is double-clicked, iii) a flick is applied in a direction of the list region 605, from a plurality of points 615 within the selected target display region 601, or iv) an open command event 617 is selected in a provided is menu in response to a menu request.

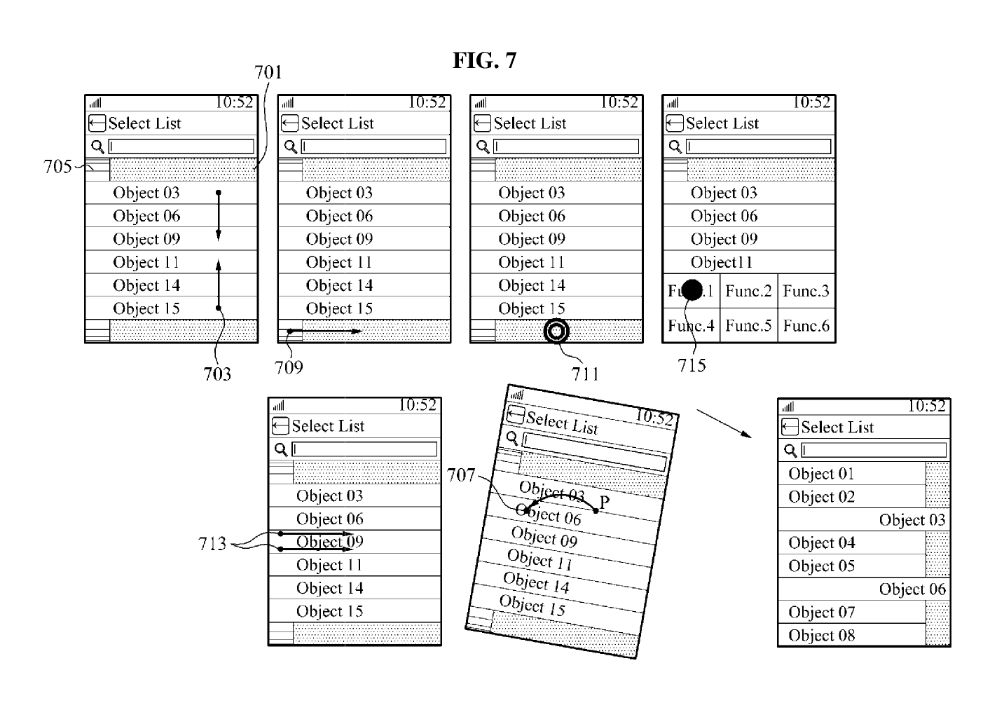

FIG. 7 is a diagram illustrating canceling hiding of a list object in a terminal apparatus using a flicking operation according to an exemplary embodiment of the invention.

Referring to FIG. 7, the terminal apparatus may cancel hiding of a list region 705 and may display an object to be arranged in the list region 705, if a touch-narrow event 703 with respect to a selected target display region 701, a narrow command event associated with a touch in the hidden list region 705, or a motion event to position a view point 707 in the list region 705 is detected.

For example, the terminal apparatus may cancel the hiding of the list region 705 and may display the object to be arranged in the list region 705, if i) a flick is inputted in an opposite direction of the list region 705, from a reference point 709 within the hidden list region 705, ii) a reference point 711 within the selected target display region 701 is double-clicked, iii) a flick is inputted in the opposite direction of the list region 705, from a plurality of points 713 within the list region 705, or iv) a narrow command event 715 is selected in a provided menu in response to a menu request.

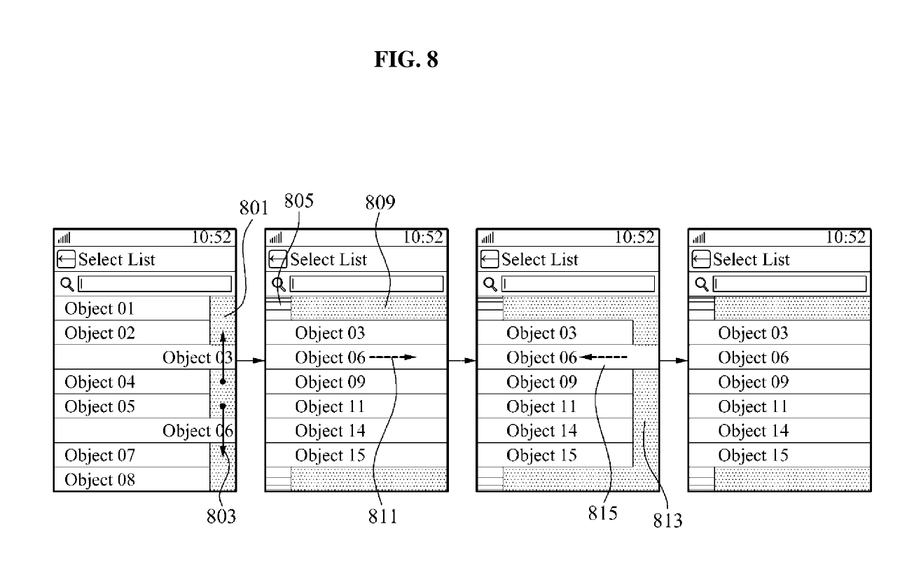

FIG. 8 is a diagram illustrating a multi-structure selection in a terminal apparatus using a flicking operation according to an exemplary embodiment of the invention.

Referring to FIG. 8, if a second flick is applied on a group object in a second direction 811 in a state in which the list region is hidden and the group object is displayed in a selected target display region 809, the terminal apparatus may assign a portion different from the selected target display region 809 as a sub-selected target display region 813. Further, the terminal apparatus may associate the group object or object 06 815, with the sub-selected target display region 813. The second direction 811 may correspond to an opposite direction of the list is region 805, which may be hidden in response to an occurrence of a touch-open event 803 with respect to a selected target display region 801.

Also, if the second flick for the object 06 815 is inputted in a direction of the list region 805, the terminal apparatus may restore the object 06 815 to arrange the group object in the selected target display region.

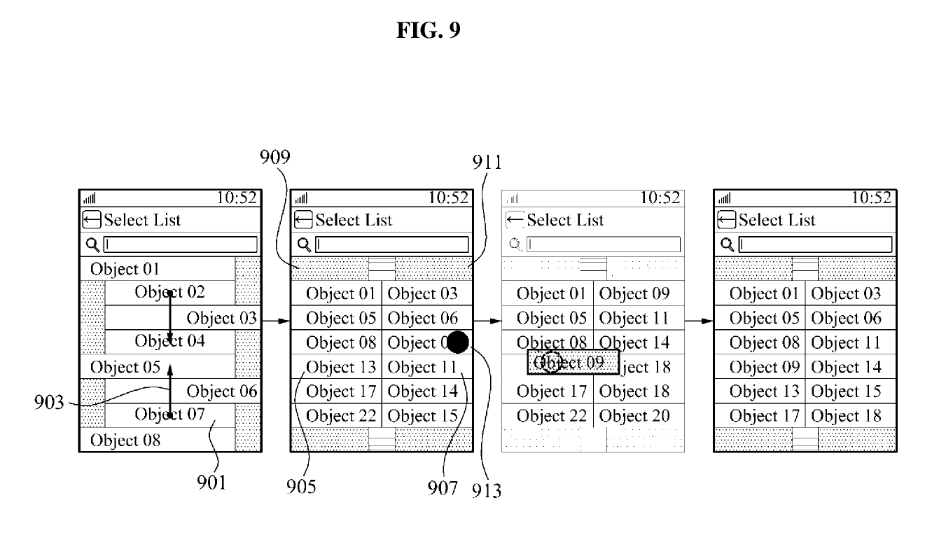

FIG. 9 is a diagram illustrating a movement of a group object between groups in a terminal apparatus using a flicking operation according to an exemplary embodiment of the invention.

Referring to FIG. 9, the terminal may hide a list region 901, and may display a first group object 905 and a second group object 907 to be arranged in a first selected target display region 909 and a second selected target display region 911, respectively, if a touch-narrow event 903 with respect to the list region 901 is detected.

Further, if a second flick operation is applied on a reference group object arranged in the second selected target display region 911, or an object 09 913, is inputted in a direction towards the first selected target display region 909, the terminal apparatus may remove the object 09 913 from the second selected target display region 911 and display the object 09 913 to be arranged in the first selected target display region 909. Accordingly, the terminal apparatus may thereby perform movement of the group object between groups.

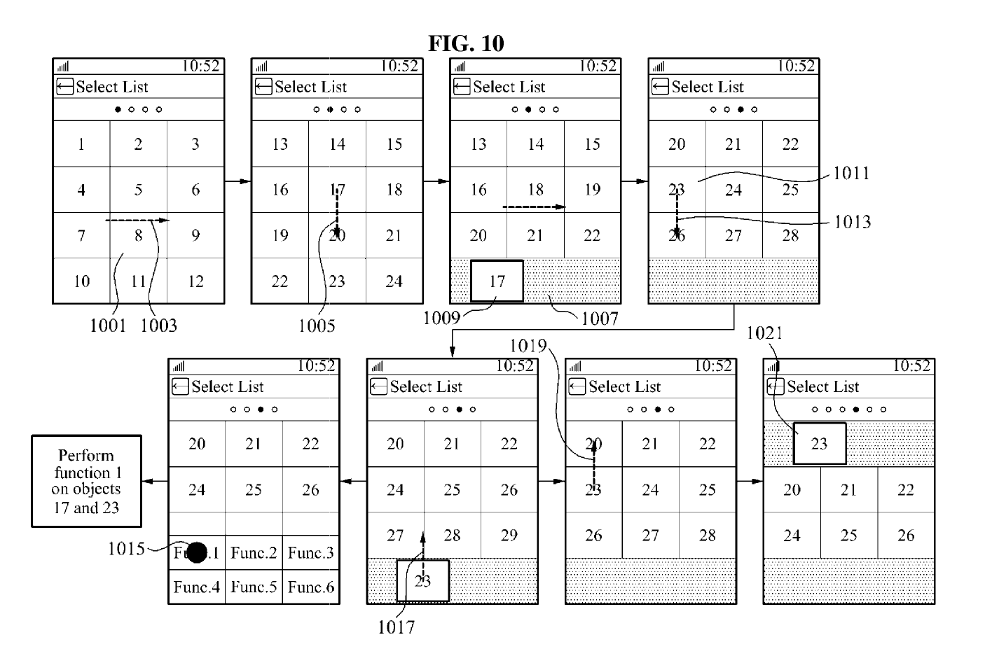

FIG. 10 is a diagram illustrating a selection of a list object in a terminal apparatus using a flicking operation according to an exemplary embodiment of the invention.

Referring to FIG. 10, if a first flick operation is applied on an object arranged in a list region 1001 in a first direction 1005, which may be different from a scrolling direction 1003 used to search for the object, the terminal apparatus may assign a portion associated with the first is direction 1005 within a display unit as a selected target display region 1007. Further, the terminal apparatus may associate the object for which the first flick is inputted, or an object 17 1009, with the selected target display region 1007 by moving the object 17 1009 from the list region 1001 to the selected target display region 1007, thereby converting the object 17 1009 into a group object.

Also, if the first flick is applied on an object 23 1011 in a first direction 1013, the terminal apparatus may convert the object 23 1011 into a group object by associating the object 23 1011 with the selected target display region 1007.

Further, the terminal apparatus may perform a function 1 1015, which may be associated with a selection input received on a provided menu, on the object 17 1009 and the object 23 1011 that are converted into group objects.

If a second flick operation is applied on the group object, object 23 1011, is inputted in a second direction 1017 of the list region 1001, the terminal apparatus may restore the group object to an original state before the first flick is inputted, or a list object, by restoring the object 23 1011, to arrange the object in the list region 1001.

Also, if the first flick operation is applied on the object 23 1011 in a second direction 1019, the terminal apparatus may assign a portion associated with the second direction 1019 within the display unit as a selected target display region 1021. Further, the terminal apparatus may associate the object for which the first flick is inputted, or the object 23 1011, with the selected target display region 1021 by moving the object 23 1011 from the list region 1001 to the selected target display region 1021, thereby converting the object 23 1011 into a group object.

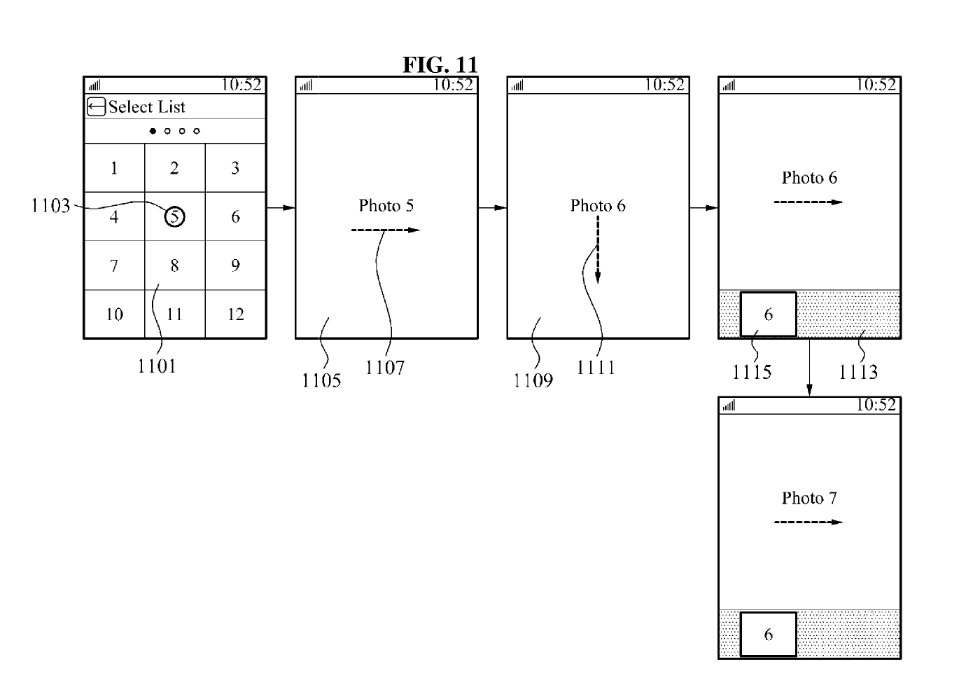

FIG. 11 is a diagram illustrating a selection of a list object in a terminal apparatus is using a flicking operation according to an exemplary embodiment of the invention.

Referring to FIG. 11, if a selection input for an object arranged in a list region 1101 is received, the terminal apparatus may display a photo 5 1105 by activating an object associated with the selected input, or an object 5 1103, and may display a photo 6 1109 associated with a following object if a flick operation is applied in a direction 1107 of a scroll used in searching for photos.

If a first flick operation is applied in a first direction 1111, which may be different from the direction 1107 of the scroll, in a state in which the photo 6 1009 is displayed, the terminal apparatus may assign a portion associated with the first direction 1111 within a display unit as a selected target display region 1113. Further, the terminal apparatus may associate an object 6 1115 corresponding to the photo 6 for which the first flick is inputted with the selected target display region 1113 by moving the object 6 1115 to the selected target display region 1113. Accordingly, the terminal apparatus may thereby convert the object 6 1115 into a group object.

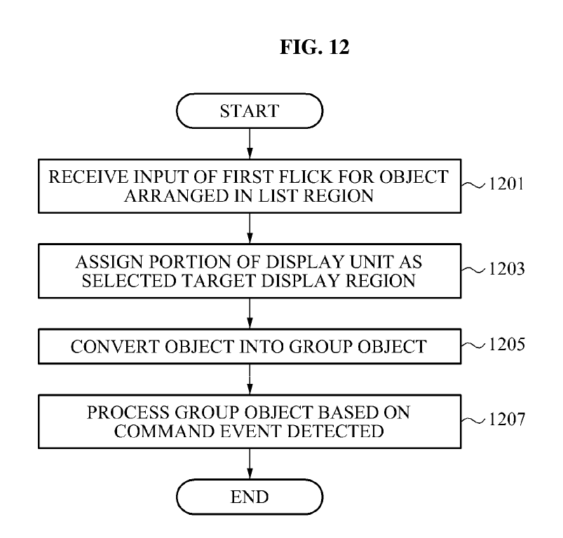

FIG. 12 is a flowchart illustrating a method for selecting a list object using a flicking operation according to an exemplary embodiment of the invention.

Referring to FIG. 12, in operation 1201, a terminal apparatus may receive an input of a first flick for an object arranged in a list region. The terminal apparatus may receive the input of the first flick in a direction different from a direction of a scroll used for searching for the object.

In operation 1203, the terminal apparatus may assign a portion of a display unit as a selected target display region. The terminal apparatus may assign the selected target display region on a side of the display unit in view of an input direction of the first flick. For example, if is the first flick is inputted in a right direction, the terminal apparatus may assign the selected target display region on a right side of the display region. If the first flick is inputted in a left direction, the terminal apparatus may assign the selected target display region on a left side of the display region.

In operation 1205, the terminal apparatus may convert the object for which the first flick is inputted into a group object by associating the object with the selected target display region. More specifically, the terminal apparatus may associate the object with the selected target display region by moving the object from the list region to the selected target display region. Further, the terminal apparatus may associate the object by controlling the object to occupy the selected target display region, that is, by expanding the object to be positioned in both the list region and the selected target display region. Although two methods for associating the object with the selected target display region are provided, association of the object with the selected target display region is not limited to these methods.

In operation 1207, the terminal apparatus may process the group object based on a received command event or a command. For example, the terminal apparatus may delete or upload the group object if a deletion command event or an upload command event is received.

In operation 1205, the terminal apparatus may receive a second flick input for a group object. If the second flick is inputted in a direction of the list region, the terminal apparatus may restore the group object as a list object. If the second flick is inputted in an opposite direction of the direction of the list region, the terminal apparatus may assign another portion of the display unit as a sub-selected target display region, and may associate the group object with the sub-selected target display region.

Further, if the second flick is inputted for the group object in a direction of the list region, the terminal apparatus may restore the group object to an original state before the first flick was inputted. More specifically, the terminal apparatus may restore the group object as the list object. The selected target display region may be assigned on the right side of the display unit and the list region may be assigned on the left side of the display unit. Also, if the second flick is inputted in a different direction, such as a direction opposite to the direction of the list region, that is, the left side of the display unit, the terminal display unit may assign the sub-selected target display region on the right side of the display unit, and may associate the group object with the sub-selected target display region, thereby supporting multi-structure selection.

Also, in operation 1205, the terminal may display a group object while hiding the list object, if a reference event occurs or is detected. In an example, the terminal apparatus may hide the list region and display the group object on the display unit by arranging the group object in the selected target display region if a touch-open event with respect to the selected target display region or a touch-narrow event with respect to the list region is detected. In an example, the touch-open event may refer to a command or an event, which requests the selected target display region to be expanded or open to view the group objects included in the selected target display region. Further, the touch-narrow event may refer to a command or an event, which requests the list region to be hidden so that the group objects included in the selected target display region may be viewed.

In another example, the terminal apparatus may hide the list region and display the group object on the display unit by arranging the group object in the selected target display region if an open command event associated with a touch in the selected target display region or a motion event to position a view point in the selected target display region is detected. In an example, the open command event associated with the touch in the selected target display region is may refer to a touch selection of the target display region to expand a view of the selected target display region. The motion event to position a view point in the selected target display region may refer to a reference movement to direct a targeted view to the selected target display region.

The terminal apparatus may display both the list object and the group object if a reference event occurs or is detected in a state in which the group object is displayed while the list object is hidden. More specifically, the terminal apparatus may cancel the hiding of the list region, and may display the object on the display unit by arranging the object in the list region if at least one of a touch-narrow event with respect to the selected target display region, a narrow command event associated with a touch in the hidden list region, and a motion event for positioning the view point in the list region is detected. In an example, the touch-narrow event with respect to the selected target display region may refer to a command or an event, which may request to reduce the size of the selected target display region. Similarly, the narrow command event associated with a touch in the hidden list region may refer to a request to restore the list region to be viewed. The motion event to position the view point in the list region may refer to a reference movement to direct a view to the hidden list region.

The terminal apparatus may perform operation 1201, operation 1203, and operation 1205 one or more times. In particular, if another flick is inputted for a list object in a direction different from a direction of a first flick that was inputted, the terminal apparatus may assign a plurality of selected target display regions including a first region and a second region, and may form a first group object associated with the first region and a second group object associated with the second region. If a second flick for a reference group object arranged in the first region is inputted in a direction towards the second region, the terminal apparatus may update and display the reference group object on the display unit by displaying the reference is group object in the second region, thereby supporting movement of the group object between the groups.

According to exemplary embodiments of the present invention, an object may be controlled in a state in which an operation of entering a selection mode is omitted. The object may be controlled by selecting, deselecting, or grouping an object based on a flick input for an object displayed in a list region of a display unit.

According to exemplary embodiments of the present invention, an object to which a command event is desired to be applied may be selected by supporting a multi-structure selection or movement of a group object between groups based on an input of a flick.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the is above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal to select a list object, comprising:
an interface to receive a first flick input for the list object;
a controller to convert the list object for which the first flick is input into a group object; and
a processing unit to process the group object according to a received command event.

2. The terminal of claim 1, wherein the interface further receives a second flick input for the group object, and the controller further restores the group object as the list object in response to the receipt of the second flick input.

3. The terminal of claim 1, wherein the controller assigns a first portion of a display as a selected target display region, and converts the list object into the group object by associating the list object with the selected target display region.

4. The terminal of claim 3, wherein the controller assigns the selected target display region on a side of the display based on a direction of the first flick input.

5. The terminal of claim 3, wherein the controller associates the list object with the selected target display region by moving the list object from a list region to the selected target display region.

6. The terminal of claim 3, wherein the controller associates the list object with the selected target display region by expanding the list object to be positioned in both a list region and the selected target display region.

7. The terminal of claim 1, wherein the controller restores the group object as the list object if the second flick input for the group object is received in a first direction, and assigns a second portion of the display screen as a sub-selected target display region if the second flick input for the group object is received in a second direction.

8. The terminal of claim 1, wherein the controller hides the list object and displays the group object if at least one of a touch-open event with respect to the selected target display region, a touch-narrow event with respect to a list region, and a motion event to position a view point in the selected target display region is detected.

9. The terminal of claim 8, wherein the controller displays both the list object and the group object if a reference event is detected in a state in which the group object is displayed and the list object is hidden.

10. The terminal of claim 1, wherein the controller moves the group object from a first group region of the selected target display region to a second group region of the selected target display region based on a reference arrangement criteria.

11. The terminal of claim 1 wherein the interface receives the first flick in a direction different from a scrolling direction of a screen used to display the list object.

12. A method for selecting a list object, comprising:
receiving a first flick input for the list object;
assigning a portion of a display of a terminal as a selected target display region;
converting the list object into a group object by associating the list object with the selected target display region; and
processing the group object based on a received command event.

13. The method of claim 12, further comprising:
receiving a second flick input for the group object; and
reverting the group object back to the list object.

14. The method of claim 12, wherein the selected target display region is assigned on a side of the display based on a direction of the first flick input.

15. The method of claim 13, wherein the group object is reverted back to the list object if the second flick input is provided in a first direction, and assigns a second portion of the display screen as a sub-selected target display region if the second flick input is received in a second direction.

16. The method of claim 12, wherein the list object is associated with the selected target display region by moving the list object from a list region to the selected target display region.

17. The method of claim 12, wherein the list object is associated with the selected target display region by expanding the list object to be positioned in both a list region and the selected target display region.

18. The method of claim 12, further comprising:
moving the group object from a first group region of the selected target display region to a second group region of the selected target display region based on a reference arrangement criteria.

19. The method of claim 12, further comprising:
hiding the list object and displaying a group object selected by the first flick if at least one of a touch-open event with respect to the selected target display region, a touch-narrow event with respect to the list region, and a motion event for positioning a view point in the selected target display region is detected.

20. The method of claim 19, wherein both the list object and the group object are displayed if a reference event is detected in a state in which the group object is displayed and the list object is hidden.

21. A method for selecting a list object, comprising:
receiving a first flick input for the list object located on a list region;
assigning a portion of a display of a terminal as a selected target display region;
converting the list object into a group object by associating the list object with the selected target display region;
receiving a second flick input for the group object;
assigning the group object to a sub-group based on a reference criteria;
hiding the list region;
receiving a command event for the group object; and
processing the group object according to the command event.
